(19) United States
(12) Patent Application Publication
(10) Pub. No.: US 2026/0067972 A1
(43) Pub. Date: Mar. 5, 2026

(54) SHORT RANGE WIRELESS STATE SYNCHRONIZATION ON RESUMING FROM STANDBY

(71) Applicant: Synaptics Incorporated, San Jose, CA (US)

(72) Inventors: Ye-Zhong Yu, Shanghai (CN); Wenxing Wu, Shenzhen (CN); Ya He, Shanghai (CN); Hong Song, Shanghai (CN)

(73) Assignee: Synaptics Incorporated, San Jose, CA (US)

(21) Appl. No.: 18/823,358

(22) Filed: Sep. 3, 2024

(51) Int. Cl. H04W 76/19; H04W 52/02

(52) U.S. Cl. CPC H04W 76/19; H04W 52/0216; H04W 52/0274

(57) ABSTRACT

This disclosure provides methods and apparatus for more quickly and reliably reestablishing short range wireless connections between a wireless computing device and paired peripheral devices after one or more processing units of the wireless computing device exit a low power state. An example method includes, prior to the one or more processing units entering the low power state, placing a short range wireless module of the wireless computing device into a known state, and then while exiting the low power state, scheduling an event notification to prevent the short range wireless module from communicating with the one or more processing units before the one or more processing units have fully exiting the low power stat.

### TECHNICAL FIELD

The present implementations relate generally to short range wireless connections in a system capable of entering and exiting a low power state, and more particularly to reconnecting a Bluetooth connection after an associated system resumes operation after exiting the low power state.

### BACKGROUND OF RELATED ART

Many wireless devices are capable of communicating using a variety of short range wireless communication protocols. For example, many cellular phones, and other mobile computing devices may use the Bluetooth communication protocol to communicate with devices such as speakers, microphones, sensors, headsets, keyboards, mice, and so on. In addition, many mobile computing devices operate using battery power, and may operate in a reduced power mode in order to conserve power. For example, a mobile computing device may be capable of entering a sleep mode, which may also be called suspend to RAM (random access memory), which may significantly reduce power consumption of the mobile computing device while enabling the device to resume operations without requiring reissuing instructions or waiting for the device to fully boot.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method for resuming a connection between a first integrated circuit and a short range wireless module. An example method is performed by the first integrated circuit and includes receiving a command to enter a low power state, receiving a command to exit the low power state, scheduling an event notification indicating an earliest time for the short range wireless module to resume communication with the first integrated circuit, and in response to exiting the low power state to the event notification, resuming communications between the short range wireless module and the first integrated circuit.

In some aspects, the method further includes, before entering the low power state in response to the received command, disabling a wireless connection provided by the short range wireless module and then reenabling the wireless connection provided by the short range wireless module. In some aspects, the wireless connection provided by the short range wireless module is in accordance with a Bluetooth communications protocol. In some aspects, reenabling the wireless connection comprises enabling a Bluetooth Low Energy (BLE) scan mode associated with the short range wireless module. In some aspects, enabling the BLE scan mode enables the short range wireless module to detect a request transmitted by a remote peripheral device paired with the short range wireless module. In some aspects, the command to exit the low power state is associated with the request transmitted by the remote peripheral device.

In some aspects, the earliest time is based at least in part on an estimated time for the first integrated circuit to exit the low power mode and be able to transmit and receive packets from the short range wireless module. In some aspects, the event notification configured the short range wireless module to wait approximately 1.2 seconds before resuming communications with the first integrated circuit.

In some aspects, the event notification is scheduled by a kernel driver associated with the first integrated circuit.

In some aspects, entering the low power state includes performing a suspend to random access memory (RAM) function at the first integrated circuit.

In some aspects, the short range wireless module and the first integrated circuit are coupled via a universal asynchronous receiver-transmitter (UART). In some aspects, scheduling the event notification further includes scheduling a wake signal to be transmitted to the short range wireless module from the first integrated circuit indicating the earliest time for the short range wireless module to resume communications with the first integrated circuit. In some aspects, scheduling the event notification configures the short range wireless module to ignore one or more UART hardware flow control signals prior to receiving the wake signal.

Another innovative aspect of the subject matter of this disclosure can be implemented in a system for resuming a connection between a first integrated circuit and a short range wireless module. An example system includes a short range wireless module and a first integrated circuit, wherein the first integrated circuit is configured to receive a command to enter a low power state, receive a command to exit the low power state, schedule an event notification indicating an earliest time for the short range wireless module to resume communication with the first integrated circuit, and in response to exiting the low power state, and in response to the event notification, resume communications between the short range wireless module and the first integrated circuit.

Another innovative aspect of the subject matter of this disclosure can be implemented as a non-transitory computer-readable storage medium storing instructions for execution by one or more processors of a first integrated circuit. Execution of the instructions causes the first integrated circuit to perform operations including receiving a command to enter a low power state, receiving a command to exit the low power state, scheduling an event notification indicating an earliest time for the short range wireless module to resume communication with the first integrated circuit, and in response to exiting the low power state to the event notification, resuming communications between the short range wireless module and the first integrated circuit.

### BRIEF DESCRIPTION OF THE DRAWINGS

The present implementations are illustrated by way of example and are not intended to be limited by the figures of the accompanying drawings.

FIG. 1 shows a block diagram of an example computing system within which the example techniques may be implemented.

FIG. 2 shows an example timing diagram depicting example timing of a method for resuming a connection between a first integrated circuit and a short range wireless module, according to some implementations.

FIG. 3 shows a block diagram of an example SoC for a computing system, according to some implementations.

FIG. 4 shows an illustrative flowchart depicting an example operation for resuming a connection between a first integrated circuit and a short range wireless module, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As described above, many wireless computing devices, such as cellular phones, tablet computers, laptops, and so on, are capable of communicating using a variety of short range wireless communication protocols, such as Bluetooth. Such wireless computing devices may include one or more central processing units, related memory and memory interfaces, input/output devices and interfaces, storage interfaces, and so on. For example, such devices and functionality may be implemented in one or more system on chip (SoC) integrated circuits. Such wireless computing devices may also include one or more modules configured to control communications in accordance with the short range wireless protocol, such as a Bluetooth module for controlling communications in accordance with Bluetooth-related protocols, such as Bluetooth Low Energy (BLE).

Because such wireless computing devices may often be mobile devices, and powered by batteries, power consumption is particularly important, and such computing devices may be capable of entering a sleep mode (suspend to RAM or random access memory), to conserve power. This sleep mode may significantly reduce power consumption of the wireless computing device while enabling the device to resume operations without requiring reissuing instructions or waiting for the device to fully boot.

However, a state mismatch problem may arise when conventional wireless computing devices resume operation after exiting the reduced power state. More particularly, a state mismatch may occur between a first integrated circuit (such as an SoC) providing the central processing functionality of the wireless computing device and a second integrated circuit providing the short range wireless functionality (such as a Bluetooth module). This may result in lost connections or delayed reconnections. For example, when the short range wireless protocol is a Bluetooth protocol, this state mismatch may result from an SoC of the wireless computing failing to respond promptly to requests from a Bluetooth module while resuming from the low power state, resulting in a failure of the Bluetooth reconnection flow. Users of such wireless computing devices may be affected by this lost connection when a Bluetooth remote (or another peripheral) is used to cause the wireless computing device to wake from a sleep mode, as the wireless computing device may successfully wake, but then lose the connection with the Bluetooth remote. This may cause problems for users due to the Bluetooth remote device not being operational after exiting sleep mode, or due to operations being delayed while the Bluetooth connection is reestablished. It would therefore be desirable to more quickly and reliably reestablish the connection between the first integrated circuit and the Bluetooth module, to avoid disconnections and delays for users of peripheral devices paired with the wireless computing device.

Various aspects relate generally to synchronizing states between a first integrated circuit and a short range wireless module, so that short range wireless connections are more quickly and reliably resumed after the first integrated circuit resumes operation after exiting a low power state. For example, while preparing to enter a low power state such as a sleep state, the short range wireless module may be powered off and then on in order to place the short range wireless module into a known state. The first integrated circuit and the short range wireless module then enter the low power state. On resuming from the low power state, a notification is scheduled for the short range wireless module, indicating a time before which the short range wireless module should not attempt to communicate with the first integrated circuit. In other words, the event notification instructs the short range wireless module to wait until the indicated time, which is configured to allow the first integrated circuit to resume operation after exiting the low power state. This wait time prevents the short range wireless module from attempting and failing to communicate with the first integrated circuit until the first integrated circuit is ready to send and receive any packets for transmission or reception by the short range wireless module.

Particular implementations of the subject matter described in this disclosure can be implemented to realize one or more of the following potential advantages. Aspects of the present disclosure may allow wireless computing devices to exit low power states while more quickly and reliably resuming short range wireless connections. This may allow users of these wireless computing devices to interact with peripheral devices more responsively. For example, a user of a remote control, smart light switch, garage door opener, speaker, microphone, or another peripheral device coupled to a wireless computing device may operate such peripheral devices more responsively as compared to conventional techniques. For example, a user operating a Bluetooth remote control coupled to a wireless computing device such as a set top box attached to a television may operate the remote control more responsively, even when the set top box has just resumed from sleep mode. This may avoid or limit user frustration with conventional devices by reducing the chances that the user will engage with the peripheral device only for the connection to the wireless computing device to be terminated, forcing the user to wait for the connection to be reestablished.

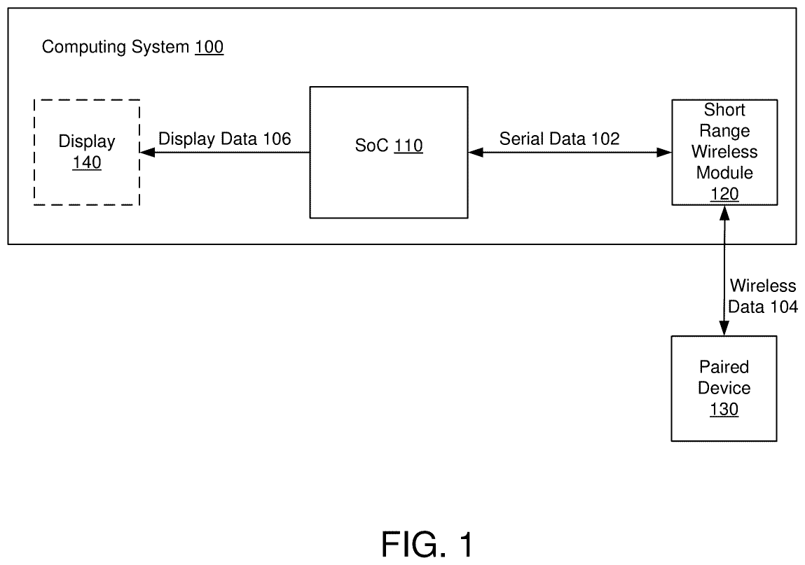

FIG. 1 shows a block diagram of an example computing system 100 within which the example techniques may be implemented. The computing system 100 includes a system on chip (SoC) 110, and a short range wireless module 120 which may be wirelessly coupled to a paired device 130. The computing system 100 may also include or be coupled to a display 140. In some implementations, the computing system may be a device such as a cellular phone, a tablet computer, a laptop computer, television set top box, or another computing device capable of wireless communication using one or more short range wireless communication protocols such as Bluetooth. For example, the computing system 100 may operate in accordance with an operating system such as Android, iOS, iPadOS, Windows, or another suitable operating system. While FIG. 1 shows the display 140 as being included in the computing system 100, in some implementations the display 140 may not be included in the computing system 100 but may instead be external to the computing system 100 and coupled to the computing system by one or more wired or wireless connections. Additionally, while the SoC 110 is shown as a single module, in some aspects the functions of the SOC may instead be provided by two or more integrated circuits which are coupled together to provide the functionality of the SoC 110.

The SoC 110 provides core functionalities for the computing system 100 by providing one or more processors, one or more memories provided within or coupled to the SoC 110, one or more storages or interfaces to storage devices coupled to the SoC 110, one or more input/output (I/O) interfaces, and so on. For example, the SoC may have one or more serial I/O interfaces for exchanging wireless data 104 with the short range wireless module 120. In some aspects, the SoC may exchange the serial data asynchronously with the short range wireless module, such as using a universal asynchronous receiver-transmitter (UART).

The short range wireless module 120 may be wirelessly coupled to one or more paired devices 130. For example, a paired device 130 may be any suitable peripheral device such as a remote control, smart light switch, garage door opener, speaker, microphone, or another peripheral device coupled to the computing system 100. For example, the SoC 110 may exchange data, such as the serial data 102 or other data communicated between the SoC 110 and the short range wireless module 120 via another I/O interface of the SoC 110. This exchanged data may include the wireless data 104 transmitted or received by the short range wireless module 120.

The SoC may also optionally provide display data 106 to the display 140, such as via one or more display interfaces of the SoC 110 coupled to the display 140.

Various components of the computing system 100 may be capable of operating in a reduced power state, such as a sleep mode (suspend to RAM), in order to conserve power. This may be particularly important when the computing system 100 is battery-powered, which is common for mobile devices such as cellular phones, tablet computers, and so on. However, as discussed above, on exiting the low power state, conventional computing systems may experience incorrect or mismatched states between the SoC 110 and the short range wireless module 120. For example, when the short range wireless module 120 is configured to communicate with the paired devices 130 in accordance with a Bluetooth protocol, this may include the SoC 110 and the short range wireless module 120 having incorrect or mismatched Bluetooth states. This may result in lost connections between the computing system 100 and the paired devices 130, and may require the connections to be reestablished, causing unwanted delays, and resulting in a poor user experience for users of the computing system 100, as actions performed using the paired devices 130 may be slow or sluggish after the computing system 100 exits the sleep mode. For example, when a paired device 130 is a Bluetooth remote control, a command entered using the remote control may be lost or delayed due to this state mismatch.

Some conventional techniques may attempt to avoid this state mismatch issue by disabling the sleep mode. However, this results in higher power consumption, which is not desirable for devices operating using battery power. Some other conventional techniques may support the sleep mode but may add functions in a user space application to check the status of the Bluetooth connection after the system resumes from sleep mode and may restart the Bluetooth service and display a pairing interface, such as on the display 140, if the connection is lost. However, this solution is slow, and may result in a worse user experience, as instead of issuing a command on the paired device 130, and then having the computing system 100 respond, the user must take steps to reestablish the connection between the computing system 100 and the paired device 130.

Aspects of the present disclosure may avoid these undesirable outcomes of the conventional techniques by ensuring that connection between the computing system 100 and the paired devices 130 are maintained after exiting the sleep mode. The example implementations may synchronize the states between the SoC 110 and the short range wireless module 120 prior to the SoC entering the sleep mode, and then ensuring that the SoC 110 is fully capable of exchanging protocol packets with the short range wireless module 120 before the short range wireless module 120 seeks to send any such protocol packets to the SoC 110.

More particularly, aspects of the example implementations may, prior to the SoC 110 entering the sleep mode, disable and then reenable the short range wireless module 120 to place it into a known state. For example, a user space application running on the SoC 110 may turn off and then turn on the short range wireless module 120. In some aspects, when the short range wireless module 120 operates in accordance with a Bluetooth protocol, reenabling the short range wireless module 120 may include enabling a Bluetooth Low Energy (BLE) scan mode associated with the short range wireless module 120. Such a BLE scan mode may allow the short range wireless module 120 to detect requests transmitted by one or more of the paired devices 130. Thus, placing the short range wireless module 120 into the BLE scan mode places the short range wireless module 120 into a known state while the SoC 110 is in sleep mode.

A command to exit the sleep mode is then received. For example, the sleep mode may be exited in response to the reception of a request transmitted by one of the paired devices 130 and may be detected by the short range wireless module 120 operating in the BLE scan mode. In some aspects, a kernel driver may be integrated into the resume flow of the SoC 110, so that as a part of the resume flow of the SoC 110 exiting sleep mode, an event notification is scheduled with the short range wireless module 120. The event notification indicates that the short range wireless module 120 is to wait for a specified time in order to transmit any protocol packets to the SoC 110. In some aspects, the event notification indicates that the short range wireless module 120 is to wait for the SoC 110 to send a signal to the short range wireless module 120 indicating that the SoC 110 is able to receive protocol packets. When the short range wireless module 120 is a Bluetooth module, such a signal may be a BT_WAKE signal. In some other aspects, the event notification indicates an amount of time the short range wireless module 120 is to wait before transmitting any protocol packets to the SoC 110. When the short range wireless module 120 is a Bluetooth module, this amount of time may be approximately 1.2 seconds, while in other aspects, the amount of time may differ based on the particular short range wireless protocol associated with the short range wireless module 120.

Thus, the example implementations place the short range wireless module 120 into a known state prior to the SoC 110 entering the sleep mode, and then on exiting the sleep mode instructs the short range wireless module 120 via the event notification, to delay sending any protocol packets to the SoC 110 for a time configured so that the SoC 110 has fully exited the sleep mode and is able to send and receive packets to and from the short range wireless module 120. In some aspects the SoC 110 and the short range wireless module 120 are coupled together via a universal asynchronous receiver-transmitter (UART). In accordance with such aspects, the event notification may indicate that the short range wireless module 120 is to ignore one or more UART hardware flow control messages which would otherwise indicate that short range wireless module 120 is clear to send protocol packets to the SoC 110. Instead, the short range wireless module 120 is instructed to wait for the BT_WAKE signal to transmit any protocol packets to the SoC 110.

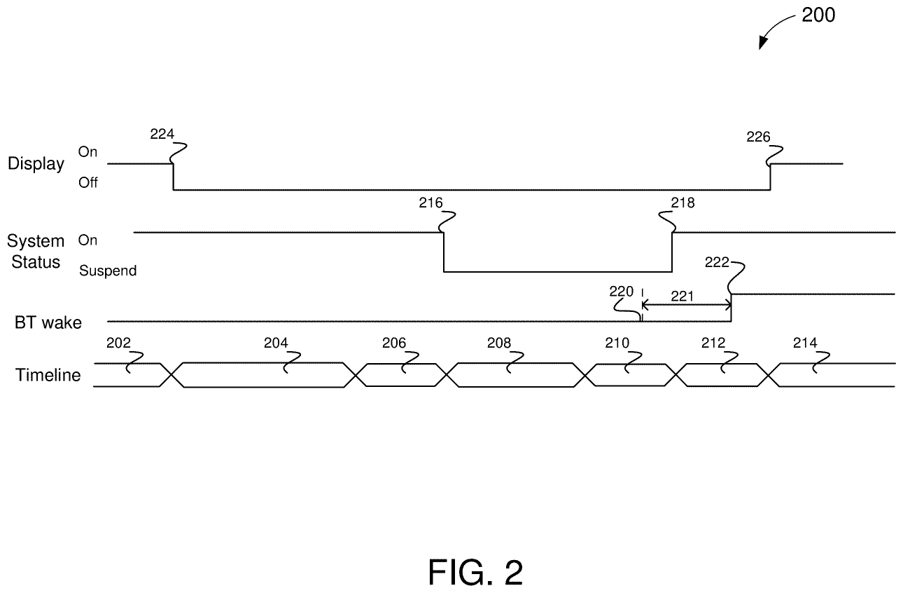

FIG. 2 shows an example timing diagram 200 depicting example timing of a method for resuming a connection between a first integrated circuit and a short range wireless module, according to some implementations. In some aspects the first integrated circuit may be the SoC 110 of FIG. 1, or one or more integrated circuits performing functions similar to those described above with respect to the SoC 110 of FIG. 1. The short range wireless module may be one example of the short range wireless module 120 of FIG. 1, and more particularly may be a Bluetooth module. FIG. 2 shows a display status, which may be a status of a display coupled to the computing system 100, such as the display 140. FIG. 2 also shows a system status, which may indicate whether or not the SoC 110 is in sleep mode. In some aspects, when the computing system 100 operates in accordance with the Android operating system, the system status may represent a status of a Linux kernel underlying the Android operating system. When the SoC 110 is in sleep mode, the system status is shown as “suspend” rather than “on.” FIG. 2 also shows the status of a BT wake signal, which indicates when the Bluetooth module may initiate communications with the SoC 110.

The example timing diagram 200 shows events occurring within a number of time periods, shown as the “Timeline” of FIG. 2. During a first time period 202 the SoC 110 and the Bluetooth module are both enabled, and the computing system 100 operates normally, allowing the Bluetooth module to facilitate communications between the SoC 110 and the paired devices 130. For example, during the first time period 202 the display 140 may remain on, and the system status is indicated as “on.”

During a second time period 204, the SoC 110 prepares to enter sleep mode. For example, the SoC 110 may be configured to enter sleep mode after a specified period of inactivity or in response to a user command. In accordance with the example implementations, the SoC 110 may disable and then reenable the Bluetooth module during the second time period 204. For example, as discussed above, reenabling the Bluetooth module may include enabling a BLE scan mode. In FIG. 2, the display is shown as turning off prior to the second time period at time 224, as often a display is turned off to conserve power prior to a device entering a sleep or suspend mode. In some other implementations the display device may be turned off in response to a user command, such as a user pressing a button on a computing device housing the SoC 110 and the short range wireless module 120. For example, when the computing device is a cellular phone or a tablet computer, typically the display may be powered off in response to a user pressing a button, such as a power button, on the phone or tablet computer.

During a third time period 206 and a fourth time period 208, the SoC may enter sleep mode. In some implementations, during the third time period 206 an operating system running on the SoC 110 may perform one or more suspend functions, while during the fourth time period 208 the SoC may perform a suspend to RAM function to place the SoC 110 into the sleep mode. For example, when the computing system 100 operates in accordance with the Android operating system, during the third time period 206 an Android suspend function may be performed, while during the fourth time period 208 a Linux suspend to RAM function may be performed to place the SoC 110 into sleep mode. Once the SoC 110 enters the sleep mode, the system status is shown as “suspend” at time 216. Note that this time is shown for simplicity and that this system status may change at any suitable time within the third time period 206 and the fourth time period 208.

During a fifth time period 210, after the SoC 110 has entered sleep mode, an external event is received, causing the SoC 110 to begin to exit sleep mode. For example, the external event may originate externally to the computing system 100, such as a request received from one of the paired devices 130. In some other aspects, the external event may be received locally to the computing system 100, such as a user request initiated at a keyboard, mouse, touch-sensitive display, or similar directly coupled to the computing system 100. In response to the reception of the external event, a resume flow may be initiated, causing the SoC 110 to exit from sleep mode. At some time during the fifth time period, indicated in FIG. 2 as time 218, the SoC exits the sleep mode, shown by the system status returning to “on” And the display subsequently returning to “on” at time 226.

As discussed above, in conventional computing systems, a short range wireless module, such as a Bluetooth module, may attempt to communicate with the SoC 110 before the SoC has completed its resume flow and before it is able to receive protocol packets, such as Bluetooth packets. For example, in such a conventional system the Bluetooth module may attempt to communicate with the SoC 110 after receiving one or more UART hardware flow control messages, such as a UART Bluetooth clear to send (CTS) message. In a conventional computing system, the BT wake signal may be asserted in response to the reception of such UART hardware control flow messages, such as at the time 220 shown in FIG. 2. As discussed above, attempts to send protocol messages to the SoC 110 before it has fully resumed after exiting the sleep mode may result in lost connections and an impaired user experience.

In accordance with the example implementations, during the resume flow in the fifth time period 210, an event notification is sent to the Bluetooth module, indicating that the Bluetooth module should not attempt to send any Bluetooth protocol packets to the SoC 110 before an indicated time. In some aspects, this event notification may cause the Bluetooth module to disregard one or more UART hardware control flow messages. In some aspects, this event notification may delay the assertion of the BT wake signal for a specified period of time, indicated in FIG. 2 by delay period 221, which may be approximately 1.2 seconds for Bluetooth modules.

During a sixth time period 212, the operating system of the SoC 110 resumes function. For example, when the computing system 100 is an Android device, during the fifth time period 210 the Linux kernel is awakened, while in the sixth time period 212 the Android operating system resumes.

When the indicated time is elapsed, the BT wake signal is asserted, shown on FIG. 2 as time 222, and the Bluetooth module may transmit protocol packets to the SoC 110. Because the delay ensured that the SoC 110 had fully resumed from sleep mode, no connections are lost, and no state mismatch results, because the Bluetooth module was placed in a known state prior to the SoC 110 entering sleep mode. This avoids the delays and lost connections which may result from conventional techniques, as discussed above.

During a seventh time period 214 the computing system 100 again operates normally. For example, the display 140 may be reenabled, and communications with the paired devices 130 resumes.

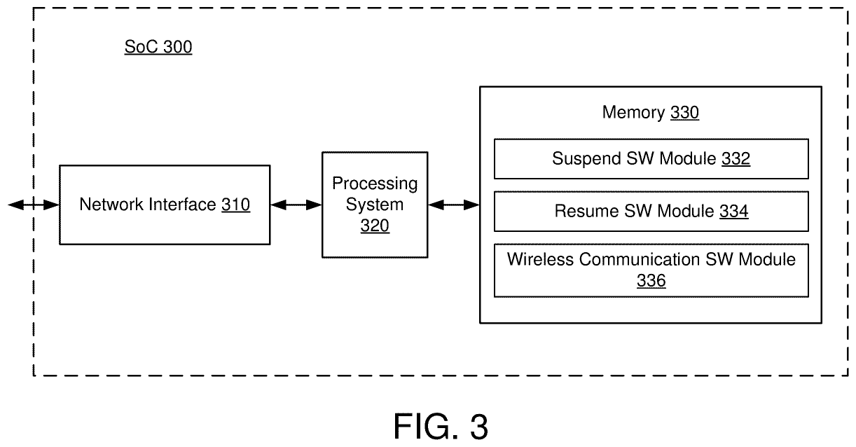

FIG. 3 shows a block diagram of an example SoC 300 for a computing system, according to some implementations. In some implementations, the SoC 300 may be one example of the SoC 110 of FIG. 1. In some aspects, the SoC 300 may be a single system on chip, while in some other aspects, the SoC 300 may include multiple integrated circuits performing the functions of the SoC 110. The computing system may be one example of the computing system 100 of FIG. 1.

The SoC 300 includes network interface 310, a processing system 320, and a memory 330. The network interface 310 may include one or more interfaces for communicating, via wired or wireless connections, with remote devices and networks, such as one or more local area networks, wide area networks, cellular networks, communicating with one or more local devices such as the paired devices 130 using one or more short range wireless protocols, and so on. More particularly, with respect to the present disclosure, the network interface 310 may couple the SoC 300 to one or more short range wireless modules, such as the short range wireless module 120 of FIG. 1, which may be a Bluetooth module.

The memory 330 may include a non-transitory computer-readable medium (including one or more nonvolatile memory elements, such as EPROM, EEPROM, Flash memory, or a hard drive, among other examples) that may store at least the following software (SW) modules:
a suspend SW module 332 to perform one or more process flows to place the SoC 300 into sleep mode;
a resume SW module 334 to perform one or more process flows to cause the SoC 300 to exit sleep mode; and
a wireless communication SW module 336 to communicate with the short range wireless module 120, such as to disable or reenable the short range wireless module 120, or to send one or more event notifications to the short range wireless module 120.

Each software module includes instructions that, when executed by the processing system 320, causes the SoC 300 to perform the corresponding functions.

The processing system 320 may include any suitable one or more processors capable of executing scripts or instructions of one or more software programs stored in the SoC 300 (such as in the memory 330). For example, the processing system 320 may execute the suspend SW module 332 to perform one or more process flows to place the SoC 300 into sleep mode. Similarly, the processing system 320 may execute the resume SW module 334 to perform one or more process flows to cause the SoC 300 to exit sleep mode. Further, the processing system 320 may execute the wireless communication SW module 336 to communicate with the short range wireless module 120, such as to disable or reenable the short range wireless module 120, or to send one or more event notifications to the short range wireless module 120.

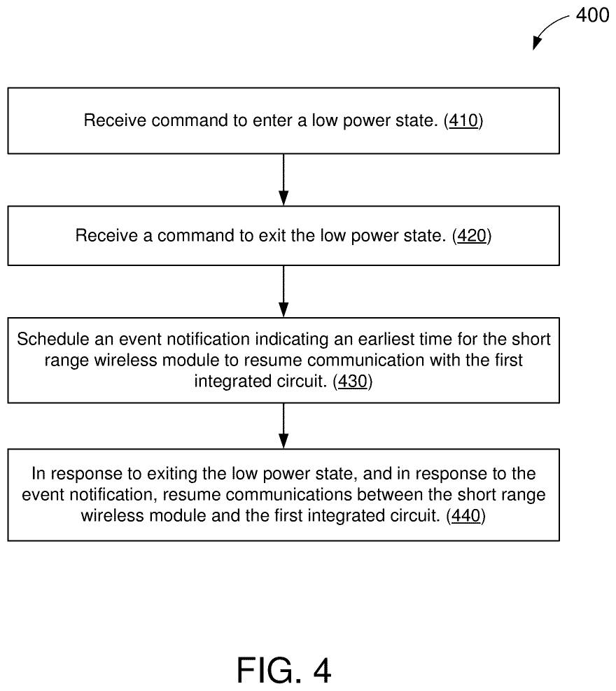

FIG. 4 shows an illustrative flowchart depicting an example operation 400 for resuming a connection between a first integrated circuit and a short range wireless module, according to some implementations. In some implementations, the example operation 400 may be performed by an SoC such as the SoC 110 of FIG. 1 or the SoC 300 of FIG. 3.

In block 410, the SoC 110 may receive a command to enter a low power state. In block 420, the SoC 110 may receive a command to exit the low power state. In block 430, the SoC may schedule an event notification indicating an earliest time for the short range wireless module to resume communication with the first integrated circuit. In block 440, the SoC 110 may, in response to exiting the low power state, and in response to the event notification, resume communications between the short range wireless module and the first integrated circuit.

In some aspects, the operation 400 further includes, before entering the low power state in response to the received command, disabling a wireless connection provided by the short range wireless module and then reenabling the wireless connection provided by the short range wireless module. In some aspects, the wireless connection provided by the short range wireless module is in accordance with a Bluetooth communications protocol. In some aspects, reenabling the wireless connection comprises enabling a Bluetooth Low Energy (BLE) scan mode associated with the short range wireless module. In some aspects, enabling the BLE scan mode enables the short range wireless module to detect a request transmitted by a remote peripheral device paired with the short range wireless module. In some aspects, the command to exit the low power state in block 420 is associated with the request transmitted by the remote peripheral device.

In some aspects, the earliest time is based at least in part on an estimated time for the first integrated circuit to exit the low power mode and be able to transmit and receive packets from the short range wireless module. In some aspects, the event notification configured the short range wireless module to wait approximately 1.2 seconds before resuming communications with the first integrated circuit.

In some aspects, the event notification is scheduled by a kernel driver associated with the first integrated circuit.

In some aspects, entering the low power state includes performing a suspend to random access memory (RAM) function at the first integrated circuit.

In some aspects, the short range wireless module and the first integrated circuit are coupled via a universal asynchronous receiver-transmitter (UART). In some aspects, scheduling the event notification in block 430 further includes scheduling a wake signal to be transmitted to the short range wireless module from the first integrated circuit indicating the earliest time for the short range wireless module to resume communications with the first integrated circuit. In some aspects, scheduling the event notification configures the short range wireless module to ignore one or more UART hardware flow control signals prior to receiving the wake signal.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for resuming a connection between a first integrated circuit and a short range wireless module, the method performed by the first integrated circuit and comprising:
receiving a command for the first integrated circuit to enter a low power state;
receiving a command to exit the low power state;
scheduling an event notification indicating an earliest time for the short range wireless module to resume communications with the first integrated circuit; and
in response to exiting the low power state, and in response to the event notification, resuming communications between the short range wireless module and the first integrated circuit.

2. The method of claim 1, further comprising, before entering the low power state in response to the received command, disabling a wireless connection provided by the short range wireless module and then reenabling the wireless connection provided by the short range wireless module.

3. The method of claim 2, wherein the wireless connection provided by the short range wireless module is in accordance with a Bluetooth communications protocol.

4. The method of claim 3, wherein reenabling the wireless connection comprises enabling a Bluetooth Low Energy (BLE) scan mode associated with the short range wireless module.

5. The method of claim 4, wherein enabling the BLE scan mode enables the short range wireless module to detect a request transmitted by a remote peripheral device paired with the short range wireless module.

6. The method of claim 5, wherein the command to exit the low power state is associated with the request transmitted by the remote peripheral device.

7. The method of claim 1, wherein the earliest time is based at least in part on an estimated time for the first integrated circuit to be able to transmit and receive packets from the short range wireless module.

8. The method of claim 1, wherein the event notification configures the short range wireless module to wait approximately 1.2 seconds before resuming communications with the first integrated circuit.

9. The method of claim 1, wherein the event notification is scheduled by a kernel driver associated with the first integrated circuit.

10. The method of claim 1, wherein entering the low power state comprises performing a suspend to random access memory (RAM) function at the first integrated circuit.

11. The method of claim 1, wherein the short range wireless module and the first integrated circuit are coupled via a universal asynchronous receiver-transmitter (UART).

12. The method of claim 11, wherein scheduling the event notification comprises scheduling a wake signal to be transmitted to the short range wireless module from the first integrated circuit indicating the earliest time for the short range wireless module to resume communications with the first integrated circuit.

13. The method of claim 12, wherein scheduling the event notification configures the short range wireless module to ignore one or more UART hardware flow control messages prior to receiving the wake signal.

14. A system for resuming a connection between a first integrated circuit and a short range wireless module, comprising:
a short range wireless module; and
a first integrated circuit, wherein the first integrated circuit is configured to:
receive a command for the system to enter a low power state;
receiving a command to exit the low power state;
schedule an event notification indicating an earliest time for the short range wireless module to resume communications with the first integrated circuit; and
in response to exiting the low power state, and in response to the event notification, resuming communications between the short range wireless module and the first integrated circuit.

15. The system of claim 14, wherein the first integrated circuit is further configured to, before entering the low power state in response to the received command, disable a wireless connection provided by the short range wireless module and then reenable the wireless connection provided by the short range wireless module.

16. The system of claim 15, wherein reenabling the wireless connection comprises enabling a Bluetooth Low Energy (BLE) scan mode associated with the short range wireless module.

17. The system of claim 16, wherein enabling the BLE scan mode enables the short range wireless module to detect a request transmitted by a remote peripheral device paired with the short range wireless module.

18. The system of claim 14, wherein the earliest time is based at least in part on an estimated time for the first integrated circuit to be able to transmit and receive packets from the short range wireless module.

19. The system of claim 14, wherein the short range wireless module and the first integrated circuit are coupled via a universal asynchronous receiver-transmitter (UART), and wherein scheduling the event notification comprises scheduling a wake signal to be transmitted to the short range wireless module from the first integrated circuit indicating the earliest time for the short range wireless module to resume communications with the first integrated circuit.

20. A non-transitory computer readable storage medium storing instructions for execution by one or more processors of a first integrated circuit wherein execution of the instructions causes the first integrated circuit to perform operations comprising:
receiving a command for the first integrated circuit to enter a low power state;
receiving a command for the first integrated circuit to exit the low power state;
scheduling an event notification indicating an earliest time for a short range wireless module coupled to the first integrated circuit to resume communications with the first integrated circuit; and
in response to exiting the low power state, and in response to the event notification, resuming communications between the short range wireless module and the first integrated circuit.
